(19) United States
(12) Patent Application Publication
(10) Pub. No.: US 2007/0297886 A1
(43) Pub. Date: Dec. 27, 2007

(54) Vehicle support device

(76) Inventors: Scott Bruce, Rockwall, TX (US); Russ Aman, Dallas, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 11/472,945

(22) Filed: Jun. 22, 2006

(51) Int. Cl. B60P 9/00

(52) U.S. Cl. 414/462

(57) ABSTRACT

A vehicle support device for supporting a vehicle within a transport member, the device comprising a base member disposed within a transport member wherein at least a portion of the base member is extendable between a pair of sidewalls of the transport member to restrict relative movement between the base member and the transport member.

### BACKGROUND OF THE INVENTION

It is common to transport vehicles, such as motorcycles, mopeds, bicycles, all-terrain vehicles (ATV's), etc. to a desired location. Supporting the transported vehicle in a truck or trailer can be problematic since in many instances the transported vehicle cannot be easily and/or adequately secured during transport. Various support structures have been devised to secure transported vehicles within trucks or trailers; however, these supports structures are not universally adaptable to different types of trucks or trailers, are bulky, are difficult to assemble/disassemble, require extensive maintenance and upkeep, and/or require a large area to store when not in use.

### BRIEF DESCRIPTION OF THE DRAWINGS

For a more complete understanding of the present invention and the advantages thereof, reference is now made to the following descriptions taken in connection with the accompanying drawings in which:

FIG. 1 is a front perspective view of an embodiment of a vehicle transport device in accordance with the present invention;

FIG. 2A is a perspective view of an embodiment of a tie-down support of the vehicle transport device of FIG. 1 in accordance with the present invention;

FIG. 2B is a perspective view of an additional embodiment of a tie down support of the vehicle transport device in accordance with an embodiment of the present invention;

FIG. 3A is a perspective view of a pair of joint connectors of the vehicle transport device of FIG. 1 in accordance with an embodiment of the present invention;

FIG. 3B is a perspective view of an additional embodiment of a pair of joint connectors of the vehicle transport device of FIG. 1 in accordance with an embodiment of the present invention;

FIG. 4 is a section view of the vehicle transport device of FIG. 1 taken along the line 4-4 of FIG. 1;

FIG. 5 is a front perspective view of an embodiment of a chock member of the vehicle transport device of FIG. 1 in accordance with the present invention; and

FIG. 6 is a section view of the vehicle transport device of FIG. 1 taken along the line 6-6 of FIG. 1.

### DETAILED DESCRIPTION OF THE DRAWINGS

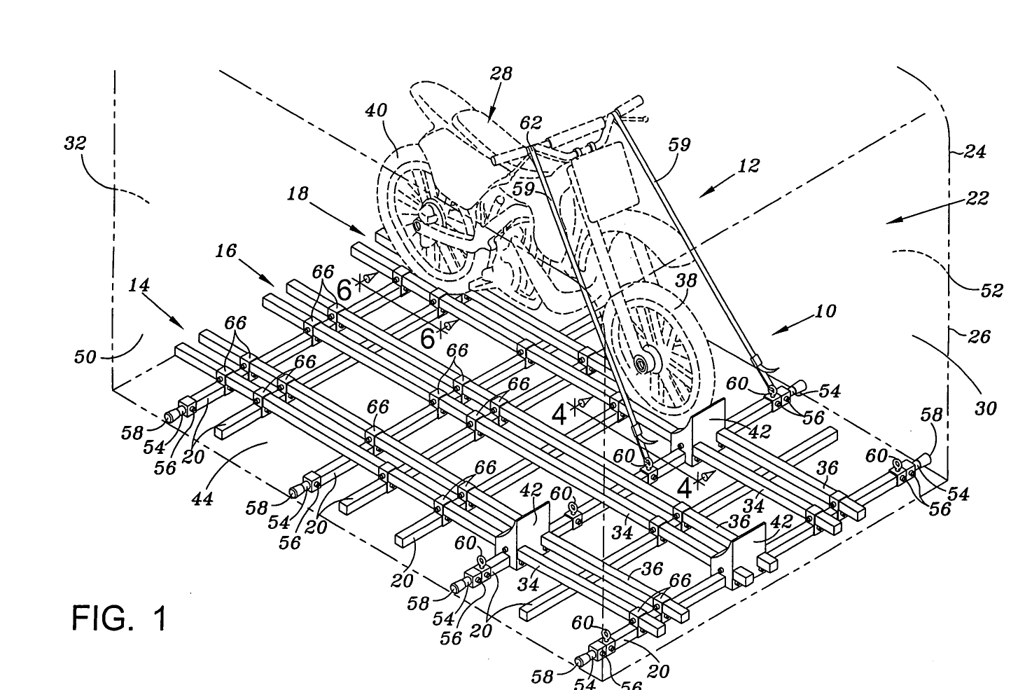

The preferred embodiments of the present invention and the advantages thereof are best understood by referring to FIGS. 1-6 of the drawings, like numerals being used for like and corresponding parts of the various drawings.

FIG. 1 is a diagram illustrating an embodiment of a vehicle support device 10 for supporting and/or transporting a vehicle 12 in accordance with an embodiment of the present invention. Vehicle support device 10 comprises track support members 14, 16 and 18 and a plurality of cross-support members 20 perpendicularly disposed relative to track support members 14, 16 and 18 forming a base member 19. While the embodiment illustrated in FIG. 1 comprises three track support members 14, 16 and 18, it should be understood that a greater or fewer number of track support members 14, 16 and/or 18 can be used. In the embodiment illustrated in FIG. 1, vehicle support device 10 is disposed within a cargo area 22 of a transport vehicle 24, such as a moving truck 26. It should be understood that transport vehicle 24 can comprise any type of vehicle suitable for transporting vehicle support device 10 and one or more transported vehicles 12, such as a trailer, a pick-up truck, a van, a cargo airplane, etc. It should be further understood that use of vehicle support device 10 is not limited to use with transport vehicles 24. Vehicle support device 10 can be adapted for use as a self-standing support structure for storing/supporting one or more vehicles 12 in a garage or other storage area. In the embodiment illustrated in FIG. 1, transported vehicle 12 comprises a motorcycle 28, however, it should be understood that transported vehicle 12 can comprise any type of vehicle 12 or combination of vehicles 12, such as mopeds, four-wheel all terrain vehicles, bicycles, etc., including different makes and models for each type of vehicle 12. When not in use, vehicle support device 10 is removable from cargo area 22 and can be disassembled for compact storage thereof, thereby enabling utilization of cargo area 22 with items/cargo other than vehicle(s) 12.

In the embodiment illustrated in FIG. 1, motorcycle 28 is secured on track support member 18 and within cargo area 22. Track support member 18, along with track support members 14 and 16, extend between front and rear walls 30 and 32, respectively, and are spaced apart a desired distance so that support members 14, 16 and 18 are positioned to support at least one motorcycle 28 (e.g., adjacent each other and/or in a spaced apart or staggered relationship relative to each other). Support members 14, 16 and 18 each comprise a pair of parallel and spaced apart rails 34 and 36 such that tires 38 and 40 of motorcycle 28 can be inserted therebetween. However, it should be understood that other configurations can be used, including, but not limited to, a single rail and/or a single “U” shaped rail. In operation, tires 38 and 40 are positioned within support members 14, 16 and/or 18 such that tires 38 and 40 are positioned between cross support members 20 to resist and/or eliminate movement of motorcycle 28 relative to base member 19. In the embodiment illustrated in FIG. 1, a chock 42 is used to engage tire 38 when inserted within track support members 14, 16 and/or 18 to resist movement of motorcycle 28 relative to support device 10. It should be understood that chock 42 can also be used to support rear tire 40 in addition to or in lieu of supporting front tire 38.

In the embodiment illustrated in FIG. 1, cross-support members 20 are disposed on floor 44 of cargo area 22 to support tracks support members 14, 16 and/or 18 while also restricting or eliminating relative movement between base 19 and cargo area 22. One or more cross-support members 20 are extendible to engage sidewalls 50 and 52 of cargo area 22. In the embodiment illustrated in FIG. 1, one or more cross-support members 20 comprise a telescoping rod 54 to lengthen or shorten cross-support members 20 in order to accommodate the differing widths of cargo areas 22. A set screw 56 secures telescoping rods 54 in fixed relation to cross-support members 20. In the embodiment illustrated in FIG. 1, telescoping rods 54 comprise a rubber stopper 58 to enable frictional engagement with walls 50 and 52. Cross-support members 20 along with telescoping rods 20 reduce or eliminate shifting of base 19 within cargo area 22. Furthermore, in some embodiments of the present invention, shifting of base 19 within cargo area 22 can be eliminated by track support members 14, 16 and/or 18 extending the entire length of cargo area 22 so as to engage front and rear walls 30 and 32 of cargo area 22.

In operation, front and rear tires 38 and 40 of motorcycle 28 are aligned with and inserted within a respective track support member 14, 16 or 18. Cross-support members 20, rails 34 and 36 and chock 42 are positioned to support tires 38 and 40 and restrict movement of motorcycle 28 relative to vehicle support device 10. In some embodiments of the present invention, straps 59 are used to secure motorcycle 28 to base member 19. Straps 59 are attached to base member 19 by one or more tie-down supports 60.

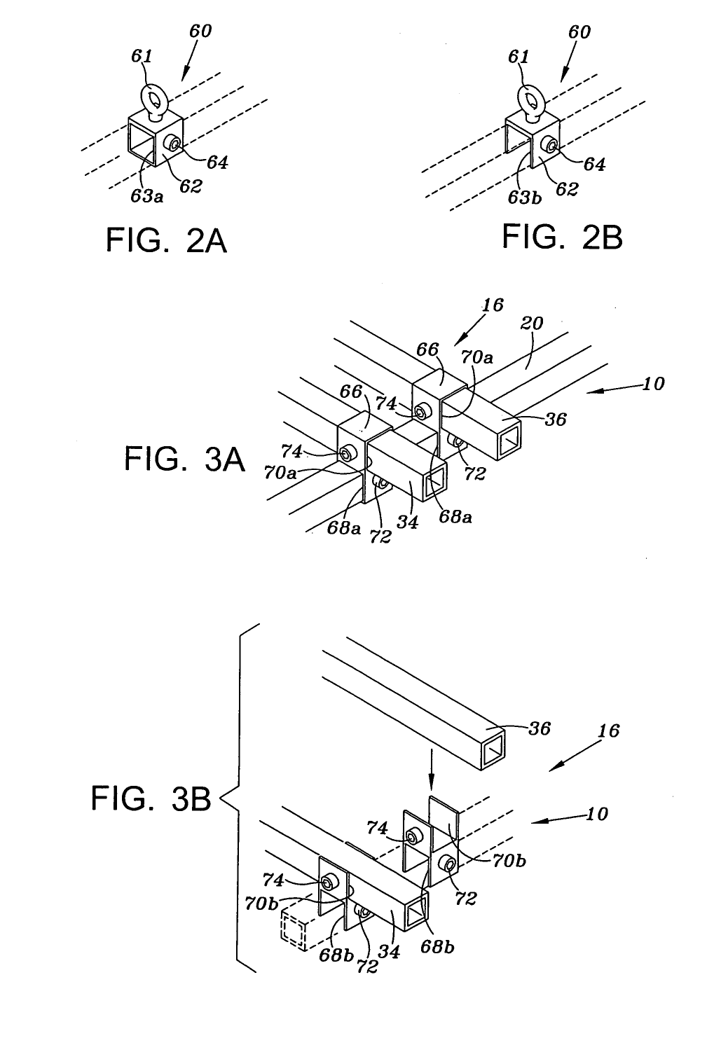

FIG. 2A is a diagram illustrating an embodiment of tie-down support 60 of FIG. 1 in accordance with the present invention. In the embodiment illustrated in FIG. 2A, tie-down support 60 comprise a ring 61 coupleable to a base member 62 to receive strap 59. Base member 62 comprises an opening 63a to receive cross-support member 20 (or rails 34 or 36 if installed thereon) and is securely fastened to cross-support member 20 (or rails 34 or 36) by a set screw 64. Tie-down members 60 are variably positionable on support device 10 by loosening set screws 64 to enable tie-down member 60 to slide along cross support member 20 (or rails 34 or 36). Alternatively, ring 61 can be couplable to joint connectors 66.

FIG. 2B is a diagram illustrating another embodiment of tie-down support 60 in accordance with the present invention. In the embodiment illustrated in FIG. 2B, tie-down support 60 comprises a ring 61 couplable to base member 62. Base member 62 comprises a recess 63b to receive cross-support member 20 (or to receive rails 34 or 36 if installed thereon) and is securely fastened to cross-support member 20 (or rails 34 or 36) with a set screw 64. Recessed area 63b enables tie-down support 60 to be easily attached and detached from base 19 without disassembly of any additional components (e.g., without removal of chocks 42, cross support members 20, etc.).

FIG. 3A is a diagram illustrating a pair of joint connectors 66 coupling cross-support member 20 to rails 34 and 36 in accordance with an embodiment of the present invention. In the embodiment illustrated in FIG. 3A, joint connectors 66 comprise a first opening 68a to receive cross-support member 20 and a perpendicularly disposed second opening 70a to receive rails 34 or 36. Openings 68a and 70a comprise a square cross-sectional area to accommodate the corresponding square cross-sections of cross-support members 20 and rails 34 and 36. It should be understood that other cross-sectional shapes (i.e., circular, oval, etc.) for openings 68a and 70a can be to accommodate different cross-sectional shapes of members 20 and rails 34 and 36 when necessary. Joint connectors 66 are variably positionable along cross-support members 20 and rails 34 and 36 to accommodate differently sized motorcycles 28 (e.g., motorcycles of different lengths, tires of different diameters and/or thickness, etc.). Set screws 72 and 74 maintain joints connectors 66 in fixed relationship with respect to cross-support members 20 and rails 34 and 36 when joint connectors 66 are at their desired positions on vehicle support device 10.

FIG. 3B is a diagram illustrating an additional embodiment of a pair of joint connectors 66 coupling cross-support member 20 to rails 34 and 36 in accordance with another embodiment of the present invention. In the embodiment illustrated in FIG. 3B, joint connectors 66 comprise a first recessed area 68b to receive cross-support member 20 and a perpendicularly disposed second recessed area 70b to receive rails 34 or 36. Recessed areas 68′ and 78′ enable joint connectors 66 to be easily attached and detached from base 19 without disassembly of additional components on base 19 (e.g., without removal of chocks 42, cross support members 20, etc.).

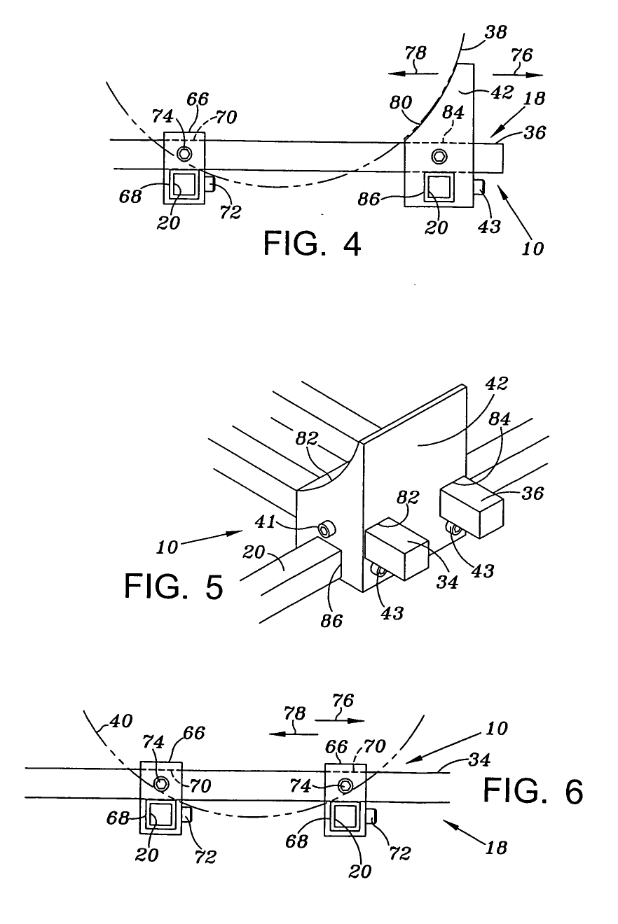

FIG. 4 is a diagram illustrating front tire 38 of motorcycle 28 disposed within track 18. In the embodiment illustrated in FIG. 4, tire 38 is supported between chock 42 and cross-support member 20 to restrict relative movement of motorcycle 28 with respect to vehicle support device 10 in the directions indicated by arrows 76 and 78 respectively. Chock 42 comprises a curved surface 80 to correspondingly engage tire 38 to resist movement in the direction indicated by arrow 76. In the embodiment illustrated in FIG. 4, cross-support member 20 is positioned to engage the rear side of tire 38 to restrict movement in the direction indicated by arrow 78. It should be understood that chock 42 can be disposed on cross support member 20 to engage the rear side of tire 38 in addition to, or lieu of, chock 42 engaging the front side of tire 38.

FIG. 5 is a diagram illustrating chock 42 in accordance with an embodiment of the present invention. In the embodiment illustrated in FIG. 5A, chock 42 is adapted to extend between rails 34 and 36 and comprises first and second openings 82 and 84 to receive rails 34 and 36, respectively. Chock 42 further comprises a transverse opening 86 to receive cross-support member 20. In order to accommodate tires 38 having a larger or smaller diameter, chock 42 can be variably positioned along rails 34 and 36 by loosening set screws 41 to accommodate the diameter of tire 38. In addition, chock 42 can be variably positioned along cross support member 20 by loosening set screws 43.

FIG. 6 is a diagram illustrating rear tire 40 of motorcycle 28 disposed within track 18. In the embodiment illustrated in FIG. 4, cross-support members 20 are positioned along track 18 to engage the front and rear sides of tire 40 to restrict movement of tire 40 in the direction indicated by arrows 76 and 78, respectively. Cross-support members 20 are coupled to and can be variably positioned along track support members 14, 16 and 18 by loosening set screws 74 to enable movement of connectors 66 to accommodate tires 38 and 40 of different sizes. Additionally, track support members 14, 16 and/or 18 can be variably positioned along cross-support member 20 by loosening set screws 72.

When not in use, vehicle transport device 10 can be disassembled for compact storage. To separate cross support members 20 from transport device 10, set screws 43, 64 and 72 on chock 42, tie-down members 60 and joint connectors 66 are all loosened to enable cross-support members 20 to be detached from transport device 10. If desired, chocks 42 and joint connectors 66 can be detached from rails 34 and/or 36 by loosening set screws 74 on joint connectors 66, and set screws 41 on chock 42. Accordingly, cross-support members 20 and rails 34 and 36 can be easily stacked/stored in a compact fashion when not in use.

Embodiments of the present invention provide support members 14, 16, 18 and/or 20 to be variably positionable to enable variable positioning of vehicle 12 on base member 19. For example, cross support members 20 can be positioned such that a plurality of vehicles 12 can be positioned in staggered relationship (e.g., one vehicle 12 positioned ahead of another vehicle 12) and/or oppositely disposed (e.g., one vehicle 12 facing in a first direction, and another vehicle 12 facing in a second direction). Furthermore, support member 14, 16 and/or 18 can be variably positionable relative to each other (e.g., closer to or further apart from each other) to accommodate a greater or fewer number of vehicles 12 positioned adjacent to each other. According to some embodiments of the present invention, base member 19 is adapted to concurrently support a plurality of different types of vehicles 12 (e.g., one or more different makes or models of motorcycles 28 and/or one or more makes or models of a moped, bicycle, four wheeled all-terrain vehicle, etc.) by variably positioning support members 14, 16, 18 and/or 20. For example, base member 19 can be configured to support a motorcycle 28 and a bicycle at the same time by variably positioning support members 14, 16, 18 and/or 20.

Thus, embodiments of the present invention provide a vehicle transport device 10 for supporting one or more transported vehicles 12 in a plurality of transport members 24, comprising telescoping cross support members 20 to enable use with transport members 24 of varying sizes while also providing for compact storage when not in use. Embodiments of the present invention also provide a vehicle support device 10 comprising a base member having support members 14, 16, 18 and/or 20 variably positionable relative to each other to enable variable positioning of the vehicle 12 on base member 19. Furthermore, embodiments of the present invention also provide a vehicle support device 10 comprising a base member 19 adapted to support at least two different types of vehicles 12. The base member 19 comprises a plurality of supports 14, 16, 18 and/or 20 variably coupleable relative to each other at a plurality of locations to accommodate at least two different types of vehicles 12.

What is claimed is:

1. A vehicle support device for supporting a vehicle within a transport member, comprising:
base member disposed within a transport member, wherein at least a portion of the base member is extendable between a pair of sidewalls of the transport member to restrict relative movement between the base member and the transport member.

2. The vehicle support device of claim 1, wherein the extendible portion of the base member frictionally engages the pair of sidewalls.

3. The vehicle support device of claim 1, wherein the base member further comprises at least one cross support member extendible between the pair of sidewalls.

4. The vehicle support device of claim 1, wherein the base member is telescopingly extendable between the pair of sidewalls.

5. The vehicle support device of claim 1, wherein the base member further comprises a track to support a vehicle.

6. The vehicle support device of claim 1, wherein the base member further comprises a tie-down member to secure the vehicle to the base member.

7. The vehicle support device of claim 1, wherein the base member comprises at least one track and at least one cross support member, wherein a joint connector couples the track to the cross support member.

8. The vehicle support device of claim 1, wherein the base member comprises a chock to restrict relative movement between the vehicle and the base member.

9. The vehicle support device of claim 8, wherein the chock is variably positionable on the base member to variably position the vehicle on the base member.

10. A vehicle support device for supporting a vehicle, comprising:
a base member configured to be located within a transport member, the base member comprising a first support member couplable to a second support member, wherein the first support member is variably positionable relative to the second support member to enable variable positioning of the vehicle on the base member.

11. The vehicle support device of claim 10, wherein the first support member comprises a pair of rails couplable to the second support member.

12. The vehicle support device of claim 10, wherein the first support member comprises at least one rail couplable to the second support member.

13. The vehicle support device of claim 10, wherein the first support member comprises a variable width to receive a vehicle.

14. The vehicle support device of claim 10, wherein the first support member is couplable to the second support member by a joint connector.

15. The vehicle support device of claim 10, wherein the base member comprises at least one tie-down member to secure the vehicle to the base member.

16. The vehicle support device of claim 10, wherein the base member comprises a chock to restrict movement of the vehicle relative to the base member.

17. A vehicle support device for supporting a vehicle within a transport member, comprising:
base member comprising a plurality of supports couplable to each other at a plurality of different locations to enable supporting of at least two different types of vehicles by the base member.

18. The vehicle support device of claim 17, further comprising at least one chock variably positionable on the base member to restrict relative movement between the base member and the vehicle.

19. The vehicle support device of claim 17, wherein the base member comprises a cross support member couplable to a track support member by a chock.

20. The vehicle support device of claim 19, wherein the chock is variably positionable along the track support member.

21. The vehicle support device of claim 19, wherein the chock is variably positionable along the cross support member.

22. The vehicle support device of claim 17, further comprising a tie-down member variably positionable on the base member.
